(19) United States
(12) Patent Application Publication
(10) Pub. No.: US 2016/0368352 A1
(43) Pub. Date: Dec. 22, 2016

(54) VEHICLE DOOR IMPACT BEAM AND METHOD OF MANUFACTURING VEHICLE DOOR IMPACT BEAM

(71) Applicants: AISIN SEIKI KABUSHISIKI KAISHA, Kariya-shi (JP); HISADA CO., LTD., Anjo-shi (JP)

(72) Inventors: Tatsuya TSUKAMOTO, Toyohashi-shi (JP); Koji YOSHIDA, Anjo-shi (JP); Kohei HODOYA, Kariya-shi (JP); Yuichi NAKAMURA, Okazaki-shi (JP); Masashi SAEKI, Toyota-shi (JP); Masahiro HASHIGUCHI, Toyota-shi (JP)

(73) Assignees: AISIN SEIKI KABUSHISIKI KAISHA, Kariya-shi (JP); HISADA CO., LTD., Anjo-shi (JP)

(21) Appl. No.: 15/188,197

(22) Filed: Jun. 21, 2016

(30) Foreign Application Priority Data
Jun. 22, 2015 (JP) 2015-124665

(51) Int. Cl. B60J 5/04

(52) U.S. Cl. CPC B60J 5/0429

(57) ABSTRACT

A vehicle door impact beam includes a main body portion and terminal portions. The main body portion includes a first bottom wall portion, a pair of first side wall portions, and a pair of first flange portions formed at ends of the first side wall portions, respectively. The first side wall portions include first wall portions respectively extending from widthwise ends of the first bottom wall portion toward one direction, and second wall portions respectively extending from ends of the first wall portions toward the one direction. The second wall portions approach each other as extending from ends on the first wall portions side toward end potions on the one direction side. The first flange portions are formed outside a space surrounded by the first bottom wall portion and the pair of first side wall portions. The terminal portions each include a second bottom wall portion, a pair of second side wall portions, and a pair of second flange portions formed at ends of the pair of second side wall portions on the one direction side, respectively. The pair of second flange portions is formed outside a space surrounded by the second bottom wall portion and the pair of second side wall portions.

### CROSS REFERENCE TO RELATED APPLICATIONS

This application is based on and claims priority under 35 U.S.C. §119 to Japanese Patent Application 2015-124665, filed on Jun. 22, 2015, the entire contents of which are incorporated herein by reference.

### TECHNICAL FIELD

The present disclosure relates to a vehicle door impact beam and a method of manufacturing vehicle door impact beam.

### BACKGROUND DISCUSSION

Hitherto, there has been known a vehicle door impact beam mounted inside a vehicle door. When an object collides with the vehicle door, the vehicle door impact beam absorbs an impact applied to the vehicle door, thereby preventing significant deformation of the vehicle door.

For example, a vehicle door impact beam described in Japanese Patent Application No. 2014-237507 (hereinafter referred to as related-art vehicle door impact beam) includes a main body portion having an elongate shape, and terminal portions formed at both longitudinal ends of the main body portion, respectively. The main body portion is formed into a shape of a groove that is open to an inner panel side of the vehicle door. That is, the main body portion includes a bottom wall portion extending in a predetermined direction to be positioned on an outer panel side of the vehicle door, and a pair of side wall portions respectively connected to both widthwise ends of the bottom wall portion to be opposed to each other. Flange portions are formed by inwardly bending ends of both the side wall portions on the inner panel side. With this configuration, flexural rigidity of the main body portion is increased as compared to a case where the flange portions are formed by outwardly bending the ends of both the side wall portions on the inner panel side.

The terminal portions are each formed into a shape of a groove similar to the shape of the main body portion. However, a configuration of the flange portions is different from that of the flange portions of the main body portion. Specifically, in the main body portion, the flange portions are formed to extend inwardly. In each of the terminal portions, the flange portions are formed to extend outwardly. That is, ends of both the side wall portions on the inner panel side of each of the terminal portions are bent outwardly.

As described above, the flange portions of each terminal portion and the flange portions of the main body portion extend in opposite directions. In general, stress is concentrated on a region (interface portion) in which a shape varies significantly. Therefore, when an object collides with the vehicle door, there is a case in that an interface portion between the main body portion and the terminal portion breaks prior to deformation of the main body portion. In this case, the main body portion is not substantially deformed, with the result that the impact is not substantially absorbed.

### SUMMARY

Thus, a need exists for a vehicle door impact beam which is not susceptible to the drawback mentioned above. For easy understanding of this disclosure, a reference sign is put in parenthesis for an element in an embodiment which corresponds to each configuration element of this disclosure; however, the configuration of each configuration element of this disclosure is not limited to that of a corresponding element in the embodiment illustrated by a reference sign.

In order to achieve the above-mentioned object, a feature of one embodiment of the present disclosure resides in a vehicle door impact beam (10) to be arranged inside a vehicle door (DR), the vehicle door impact beam comprising: a main body portion (20) formed into an elongate shape; and a pair of terminal portions (30) formed at both longitudinal ends of the main body portion, respectively, wherein the main body portion comprises: a first bottom wall portion (21) extending in a predetermined direction; a pair of first side wall portions (22,23) being connected to both widthwise ends of the first bottom wall portion, respectively, and extending in the predetermined direction to be opposed to each other; and a pair of first flange portions (24,25) respectively extending from widthwise ends of the pair of first side wall portions in a direction away from each other, wherein the main body portion is formed into a shape of a groove that is open in one direction, wherein the first side wall portion comprises: a pair of first wall portions (221,231) respectively extending from the both widthwise ends of the first bottom wall portion toward the one direction; and pair of second wall portions (222,232) respectively extending from ends of the pair of first wall portions on the one direction side toward the one direction, and being inclined so as to approach each other as extending from ends of the pair of second wall portions on the pair of first wall portions side toward ends of the pair of second wall portions on the one direction side, wherein the terminal portion comprises: a second bottom wall portion (31) extending in the predetermined direction; a pair of second side wall portions (32,33) being connected to both widthwise ends of the second bottom wall portion, respectively, and extending in the predetermined direction to be opposed to each other; and a pair of second flange portions (34,35) respectively extending from widthwise ends of the pair of second side wall portions in a direction away from each other, wherein the terminal portion is formed into a shape of a groove that is open in the one direction, wherein the pair of second side wall portions are inclined away from each other as extending from ends of the pair of second side wall portions on the second bottom wall portion side toward ends of the pair of second side wall portions on the one direction side.

The present disclosure is not limited to application to the vehicle door impact beam, but is also applicable to a method of manufacturing the vehicle door impact beam.

### BRIEF DESCRIPTION OF THE DRAWINGS

FIG. 1 is a schematic view of a vehicle to which a vehicle door impact beam according to the present disclosure is applied.

FIG. 2 is an enlarged view of a door part of FIG. 1.

FIG. 3 is a front view of the vehicle door impact beam of FIG. 1.

FIG. 4 is an enlarged perspective view of a front terminal portion of the vehicle door impact beam of FIG. 1.

FIG. 5 is a cross-sectional view taken along the line I-I of FIG. 2.

FIG. 6 is a cross-sectional view taken along the line II-II of FIG. 2.

FIG. 7 is a cross-sectional view taken along the line III-III of FIG. 2.

FIG. 8 is a schematic view of a roll forming apparatus.

FIG. 9 is a perspective view of an intermediate formed product.

FIG. 10 is a graph for showing a comparison between flexural rigidity of a related-art vehicle door impact beam and flexural rigidity of the vehicle door impact beam according to the present disclosure.

FIG. 11 is a cross-sectional view of a main body portion of the vehicle door impact beam according to a modified example of the present disclosure when taken along a direction perpendicular to a longitudinal direction of the vehicle door impact beam.

### DETAILED DESCRIPTION

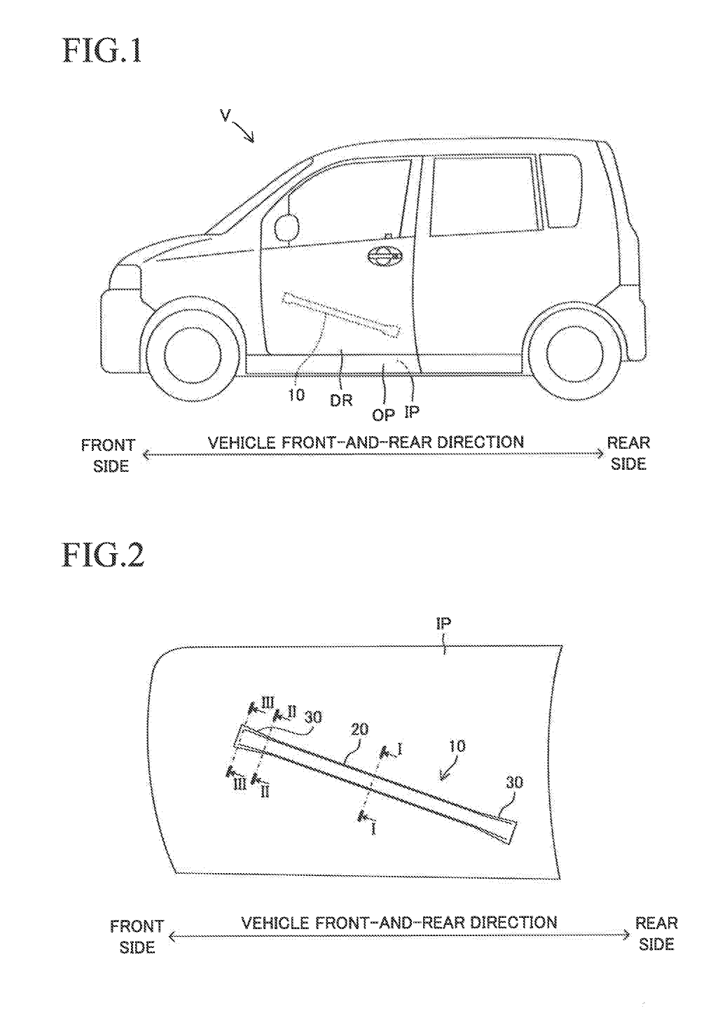

Now, a vehicle door impact beam 10 according to an embodiment of the present disclosure is described. First, an outline of a vehicle V to which the vehicle door impact beam 10 is mounted is described. As illustrated in FIG. 1, a door DR is mounted to a frame (component constructing a frame of a vehicle cabin) of the vehicle V in an openable and closable manner. The vehicle door impact beam 10 according to this embodiment is mounted inside the door DR. As is well known, the door DR includes an outer panel OP and an inner panel IP, and the vehicle door impact beam 10 is arranged between the outer panel OP and the inner panel IP. The vehicle door impact beam 10 is fixed to the inner panel IP. In this embodiment, description is made of an example in which the vehicle door impact beam 10 is mounted to the left door DR of the vehicle V. However, the present disclosure is also applicable to a vehicle door impact beam mounted to another door.

As illustrated in FIG. 2, the vehicle door impact beam 10 is formed into an elongate shape, and is arranged to extend from a front end to a rear end of the inner panel IP. The vehicle door impact beam 10 is fixed in an inclined posture to the inner panel IP so that a front end side of the vehicle door impact beam 10 is positioned above a rear end side thereof.

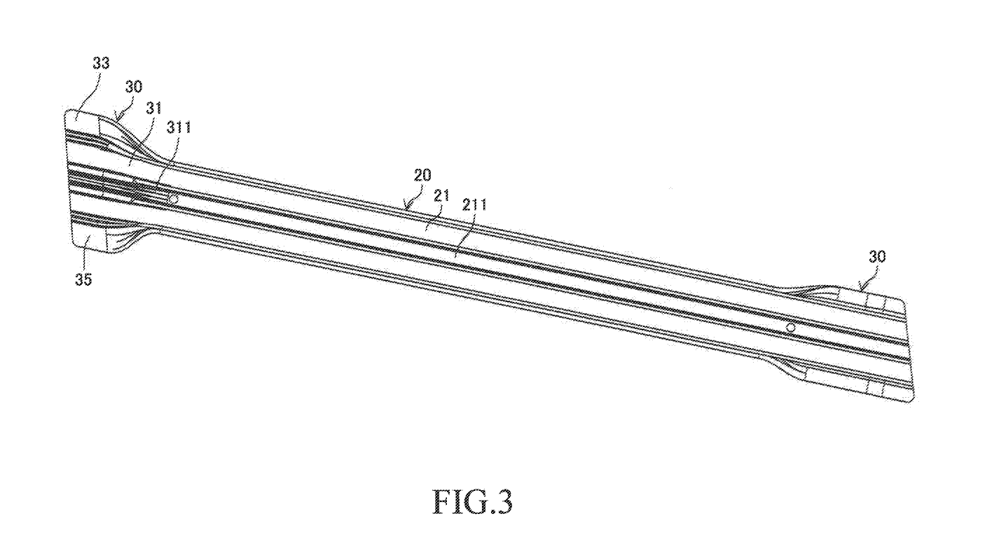

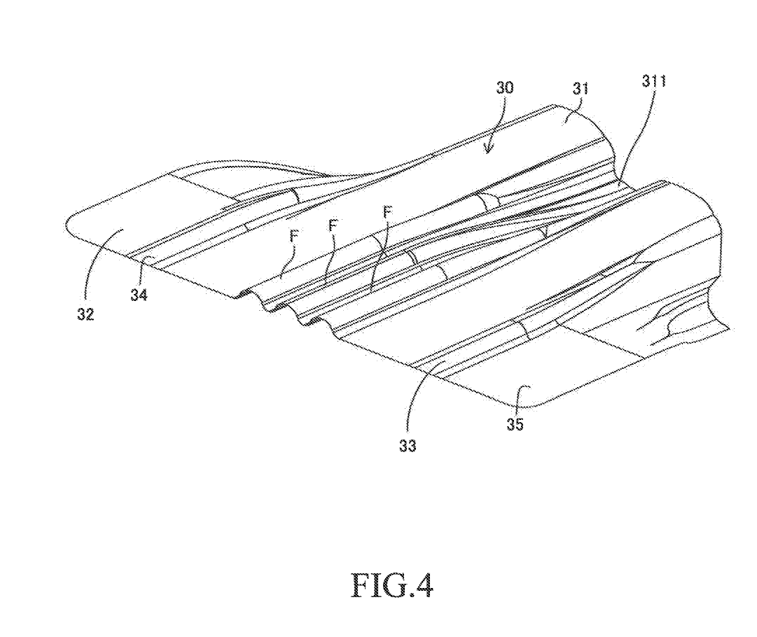

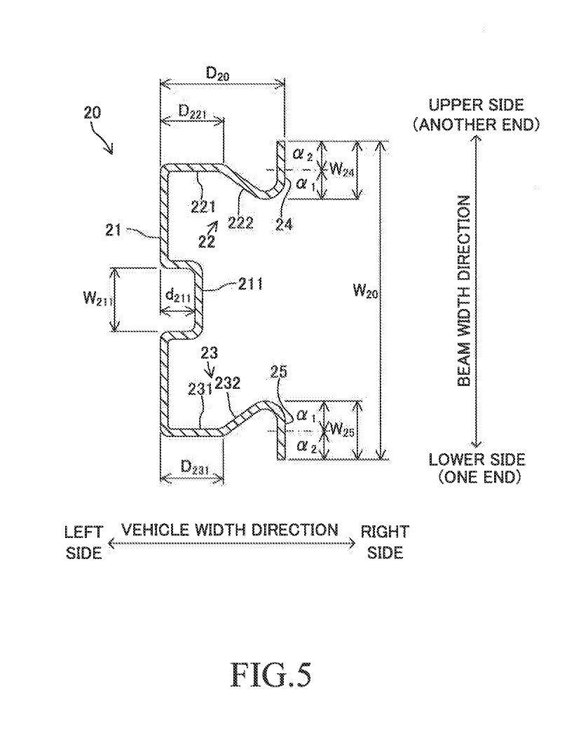

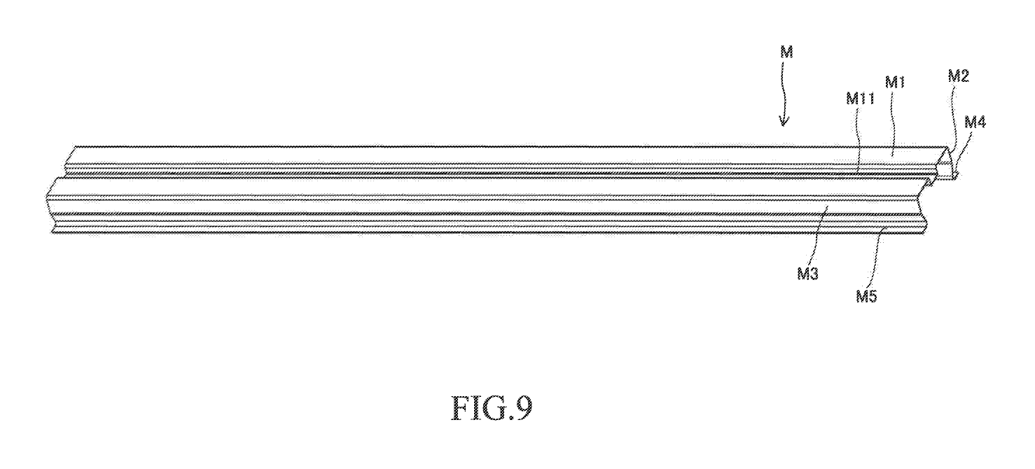

The vehicle door impact beam 10 is manufactured by pressing both longitudinal ends of a grooved intermediate formed product M (see FIG. 9) manufactured using a roll forming method as described later in detail. As illustrated in FIG. 3 and FIG. 4, the vehicle door impact beam 10 includes a main body portion 20 having an elongate shape, and terminal portions 30 and 30 formed at both longitudinal ends of the main body portion 20, respectively.

Next, a shape of the vehicle door impact beam 10 is described with reference to FIG. 5 to FIG. 7. A right-and-left direction of the drawing sheets of FIG. 5 to FIG. 7 corresponds to a vehicle width direction. As illustrated in FIG. 5 to FIG. 7, a vehicle inner side of the vehicle door impact beam 10 is defined as a right side. Further, a vehicle outer side of the vehicle door impact beam 10 is defined as a left side. Further, a direction perpendicular to the drawing sheets of FIG. 5 to FIG. 7 is defined as a beam longitudinal direction. The beam longitudinal direction is orthogonal to the vehicle width direction. Further, an up-and-down direction of the drawing sheets of FIG. 5 to FIG. 7, that is, a direction orthogonal to both the beam longitudinal direction and the vehicle width direction is defined as a beam width direction. One end side of the vehicle door impact beam 10 in the beam width direction is defined as a lower side. Further, another end side of the vehicle door impact beam 10 in the beam width direction is defined as an upper side.

As illustrated in FIG. 5, the main body portion 20 is formed to have an open cross-section when taken along a direction perpendicular to the beam longitudinal direction, that is, to have a cross-section having no closed space inside the main body portion 20. The main body portion 20 is formed into a shape of a groove that extends in the beam longitudinal direction and is open rightward (in one direction). That is, a groove depth direction of the main body portion 20 corresponds to the vehicle width direction. A cross-sectional shape of the main body portion 20 is always uniform when taken along the direction perpendicular to the beam longitudinal direction.

The main body portion 20 includes a bottom wall portion 21, side wall portions 22 and 23, and flange portions 24 and 25. The bottom wall portion 21 is formed into a plate-like shape extending in the beam longitudinal direction. A thickness direction of the bottom wall portion 21 corresponds to the vehicle width direction. Further, a width direction of the bottom wall portion 21 (direction perpendicular to both a longitudinal direction and the thickness direction of the bottom wall portion 21) corresponds to the beam width direction. A recessed portion 211 extending in the beam longitudinal direction is formed in a left surface of the bottom wall portion 21. The recessed portion 211 is formed in a center portion of the bottom wall portion 21 in the beam width direction. The recessed portion 211 is open leftward.

The side wall portion 22 includes a perpendicular portion 221 and an inclined portion 222. The perpendicular portion 221 is formed into a plate-like shape extending rightward from an upper end of the bottom wall portion 21 and extending in the beam longitudinal direction. The perpendicular portion 221 is perpendicular to the bottom wall portion 21. The inclined portion 222 is formed into a plate-like shape extending rightward and downward (that is, toward an inside of the main body portion 20 (inside of the groove)) from a right end of the perpendicular portion 221 and extending in the beam longitudinal direction.

The side wall portion 23 includes a perpendicular portion 231 and an inclined portion 232. The perpendicular portion 231 is formed into a plate-like shape extending rightward from a lower end of the bottom wall portion 21 and extending in the beam longitudinal direction. The perpendicular portion 231 is perpendicular to the bottom wall portion 21. The inclined portion 232 is formed into a plate-like shape extending rightward and upward (that is, toward the inside of the main body portion 20 (inside of the groove)) from a right end of the perpendicular portion 231 and extending in the beam longitudinal direction.

In other words, the inclined portion 222 and the inclined portion 232 are inclined so as to approach each other as extending from the outer panel side (left side) to the inner panel IP side (right side).

The flange portion 24 is formed into a plate-like shape extending upward from a right lower end of the inclined portion 222 and extending in the beam longitudinal direction. That is, the flange portion 24 is formed outside a space surrounded by the bottom wall portion 21, the side wall portion 22, and the side wall portion 23. A connection portion between the flange portion 24 and the inclined portion 222 is curved significantly. The flange portion 25 is formed into a plate-like shape extending downward from a right upper end of the inclined portion 232 and extending in the beam longitudinal direction. That is, the flange portion 25 is formed outside the space surrounded by the bottom wall portion 21, the side wall portion 22, and the side wall portion 23. A connection portion between the inclined portion 232 and the flange portion 25 is curved significantly.

A dimension of the main body portion 20 in the longitudinal direction is 525 mm. A dimension W₂₀ of the bottom wall portion 21 of the main body portion 20 in the beam width direction is 85 mm. A dimension D₂₀ of the main body portion 20 in the vehicle width direction is 35 mm. A dimension D₂₂₁ of the perpendicular portion 221 of the side wall portion 22 and a dimension D₂₃₁ of the perpendicular portion 231 of the side wall portion 23 in the vehicle width direction are 17 mm. Further, a dimension W₂₄ of the flange portion 24 and a dimension W₂₅ of the flange portion 25 in the beam width direction are 17 mm. It is preferred that a dimension α₁ of a portion of the flange portion 24 or 25 positioned on an inner side of the main body portion 20 with respect to the perpendicular portion 221 or 231 be equal to a dimension α₂ of a portion of the flange portion 24 or 25 positioned on an outer side of the main body portion 20 with respect to the perpendicular portion 221 or 231. Further, a width W₂₁₁ of the recessed portion 211 is 20 mm. Further, a depth d₂₁₁ of the recessed portion 211 is 10 mm.

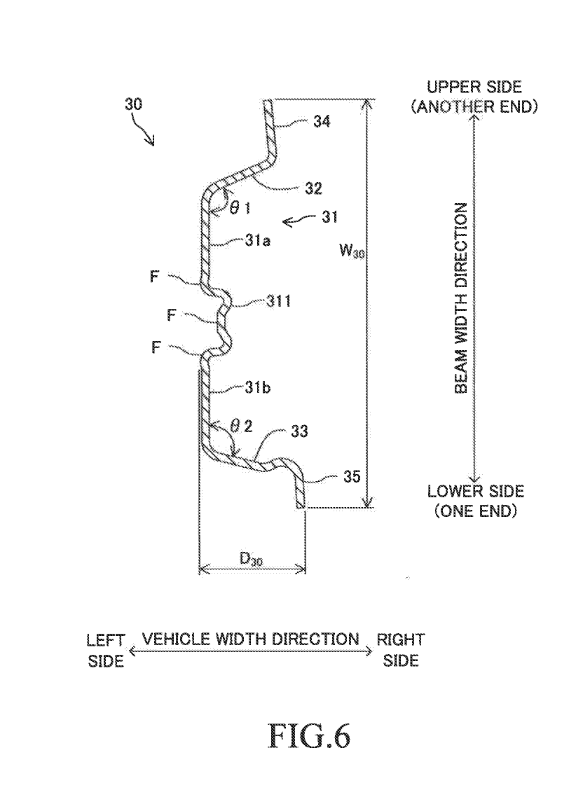

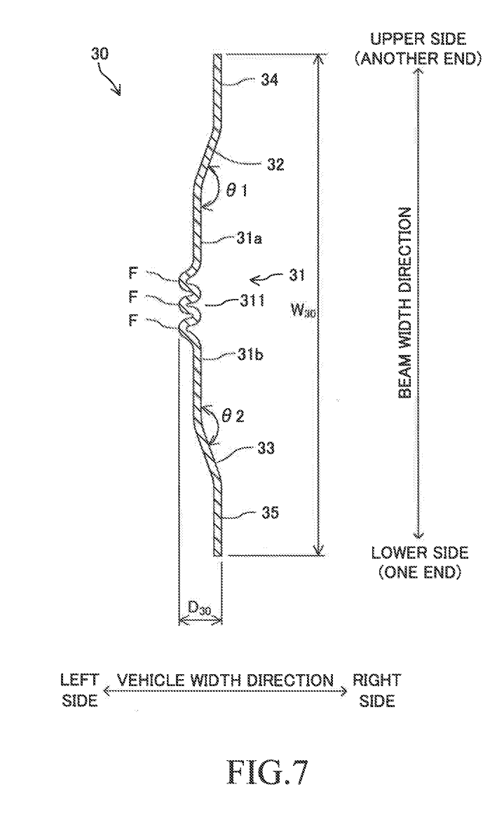

As illustrated in FIG. 6 and FIG. 7, each terminal portion 30 is formed to have an open cross-section when taken along the direction perpendicular to the beam longitudinal direction, that is, to have a cross-section having no closed space inside the terminal portion 30. The terminal portion 30 is formed into a shape of a groove that extends in the beam longitudinal direction and is open rightward. That is, a groove depth direction of the terminal portion 30 corresponds to the vehicle width direction. As described above, the cross-sectional shape of the main body portion 20 is always uniform when taken along the direction perpendicular to the beam longitudinal direction. In contrast, a cross-sectional shape of the terminal portion 30 taken along the direction perpendicular to the beam longitudinal direction gradually varies as the terminal portion 30 extends from a proximal end side to a distal end side of the terminal portion 30.

The terminal portion 30 includes a bottom wall portion 31, side wall portions 32 and 33, and flange portions 34 and 35. The bottom wall portion 31 includes plate-like portions 31a and 31b each formed into a plate-like shape extending in the beam longitudinal direction. A thickness direction of each of the plate-like portions 31a and 31b is slightly inclined to the beam longitudinal direction and the vehicle width direction. That is, a distal end side (side opposite to a connection portion between the main body portion 20 and the terminal portion 30) of the bottom wall portion 31 is closer to the inner panel IP than a proximal end side (connection portion side between the main body portion 20 and the terminal portion 30) of the plate-like portions 31a and 31b. Further, a width direction of each of the plate-like portions 31a and 31b (direction perpendicular to the longitudinal direction and the thickness direction of the bottom wall portion 31) corresponds to the beam width direction. The plate-like portions 31a and 31b are separated from each other in the beam width direction. A recessed portion 311 extending in the longitudinal direction of the bottom wall portion 31 is formed between the plate-like portion 31a and the plate-like portion 31b. The recessed portion 311 is continuous with the recessed portion 211 of the main body portion 20. The recessed portion 311 is open leftward. Three protruding portions F extending in the longitudinal direction of the recessed portion 311 and protruding leftward are formed on the recessed portion 311. However, in this embodiment, the protruding portions F are formed only on the front terminal portion 30, whereas the protruding portions F are not formed on the rear terminal portion 30. However, the protruding portions F may be formed on each of the terminal portions 30 and 30. The protruding portions F are formed by folding a bottom wall portion of the recessed portion 311 and by folding the vicinity of a connection portion between the recessed portion 311 and each of the plate-like portions 31a and 31b. A protruding height of each of the protruding portions F gradually increases as the protruding portions F extend from the proximal end side to the distal end side of each of the terminal portions 30. At the distal end of each of the terminal portions 30, the protruding portions F protrude leftward from left surfaces of the plate-like portions 31a and 31b, and right surfaces of recessed portions between the adjacent protruding portions F are flush with right surfaces of the plate-like portions 31a and 31b (see FIG. 7).

The side wall portion 32 is formed into a plate-like shape extending rightward from an upper end of the bottom wall portion 31 (plate-like portion 31a) and extending in the beam longitudinal direction. In a cross-section of the proximal end of the terminal portion 30, a cross-sectional shape of the side wall portion 32 taken along the direction perpendicular to the beam longitudinal direction is the same as the cross-sectional shape of the side wall portion 22 in a cross-section I (FIG. 5) of the main body portion 20. That is, at the proximal end of the terminal portion 30, the side wall portion 32 includes a perpendicular portion perpendicular to the bottom wall portion 31, and an inclined portion extending rightward and downward (that is, toward the inside of the terminal portion 30 (inside of the groove)) from a right end of the perpendicular portion. Further, at a portion of the terminal portion 30, which is positioned slightly closer to the distal end side of the terminal portion 30 with respect to the proximal end thereof (at the vicinity of a cross-section II (FIG. 6)), the side wall portion 32 exhibits a flat-plate-like shape. In the cross-section II, an angle θ1 between the side wall portion 32 and the bottom wall portion 31 is larger than 90°. Further, at the distal end of the terminal portion 30 (at the vicinity of a cross-section III (FIG. 7)), the side wall portion 32 exhibits a flat-plate-like shape. The angle θ1 in the cross-section III is larger than the angle θ1 in the cross-section II.

The side wall portion 33 is formed into a plate-like shape extending rightward from a lower end of the bottom wall portion 31 (plate-like portion 31b) and extending in the beam longitudinal direction. In the cross-section of the proximal end of the terminal portion 30, a cross-sectional shape of the side wall portion 33 taken along the direction perpendicular to the beam longitudinal direction is the same as the cross-sectional shape of the side wall portion 23 in the cross-section I (FIG. 5) of the main body portion 20. That is, at the proximal end of the terminal portion 30, the side wall portion 33 includes a perpendicular portion perpendicular to the bottom wall portion 31, and an inclined portion extending rightward and upward (that is, toward the inside of the terminal portion 30 (inside of the groove)) from a right end of the perpendicular portion. Further, at the vicinity of the cross-section II (FIG. 6), the side wall portion 33 exhibits a flat-plate-like shape. In the cross-section II, an angle θ2 between the side wall portion 33 and the bottom wall portion 31 is larger than 90°. Further, at the vicinity of the cross-section III (FIG. 7), the side wall portion 33 exhibits a flat-plate-like shape. The angle θ2 in the cross-section III is larger than the angle θ2 in the cross-section II.

In other words, portions of the side wall portion 32 and the side wall portion 33 excluding the proximal ends are inclined away from each other as extending from the outer panel side (left side) to the inner panel IP side (right side).

The flange portion 34 is formed into a plate-like shape extending upward from an upper end of the side wall portion 32 and extending in the beam longitudinal direction. That is, the flange portion 34 is formed outside a space surrounded by the bottom wall portion 31, the side wall portion 32, and the side wall portion 33. In the cross-section of the proximal end of the terminal portion 30 taken along the direction perpendicular to the beam longitudinal direction, similarly to the connection portion between the flange portion 24 and the side wall portion 22 in the cross-section I (FIG. 5) of the main body portion 20, a connection portion between the flange portion 34 and the side wall portion 32 is curved significantly. In contrast, in the cross-section II (FIG. 6) and the cross-section III (FIG. 7), a significant curve is not formed at the connection portion between the flange portion 34 and the side wall portion 32.

The flange portion 35 is formed into a plate-like shape extending downward from a lower end of the side wall portion 33 and extending in the beam longitudinal direction. That is, the flange portion 35 is formed outside the space surrounded by the bottom wall portion 31, the side wall portion 32, and the side wall portion 33. In the cross-section of the proximal end of the terminal portion 30 taken along the direction perpendicular to the beam longitudinal direction, similarly to the connection portion between the flange portion 25 and the side wall portion 23 in the cross-section I (FIG. 5) of the main body portion 20, a connection portion between the flange portion 35 and the side wall portion 33 is curved significantly. Further, also in the cross-section II (FIG. 6), the connection portion between the flange portion 35 and the side wall portion 33 is curved significantly, and the curved portion protrudes to the inside of the terminal portion 30. However, in the cross-section III (FIG. 7), a significant curve is not formed at the connection portion between the flange portion 35 and the side wall portion 33.

As described above, the angles 81 and 82 gradually increase as the terminal portion 30 extends from the proximal end side to the distal end side thereof. Accordingly, a dimension W₃₀ of the terminal portion 30 in the beam width direction gradually increases, and a dimension D₃₀ of the terminal portion 30 in the vehicle width direction gradually decreases. In the cross-section II, the dimension W₃₀ is 65 mm, and the dimension D₃₀ is 15 mm. Further, in the cross-section III, the dimension W₃₀ is 70 mm, and the dimension D₃₀ is 8 mm.

Next, a method of manufacturing the vehicle door impact beam 10 is described. In this embodiment, the vehicle door impact beam 10 is manufactured through a roll forming step, a partial heat-treating step, a cutting step, and a deforming step.

In the roll forming step, roll forming is performed on a metal steel plate having a flat-plate-like shape, thereby manufacturing a roll formed product having the same cross-sectional shape as the cross-sectional shape of the main body portion 20 of the vehicle door impact beam 10. The roll forming step is performed using a roll forming apparatus.

Further, in the partial heat-treating step, the roll formed product is partially heat-treated along a longitudinal direction of the roll formed product. Thus, a heat-treated portion and a non-heat-treated portion are formed in the roll formed product. In this embodiment, a heat-treating device configured to perform the partial heat-treating step is incorporated into the roll forming apparatus.

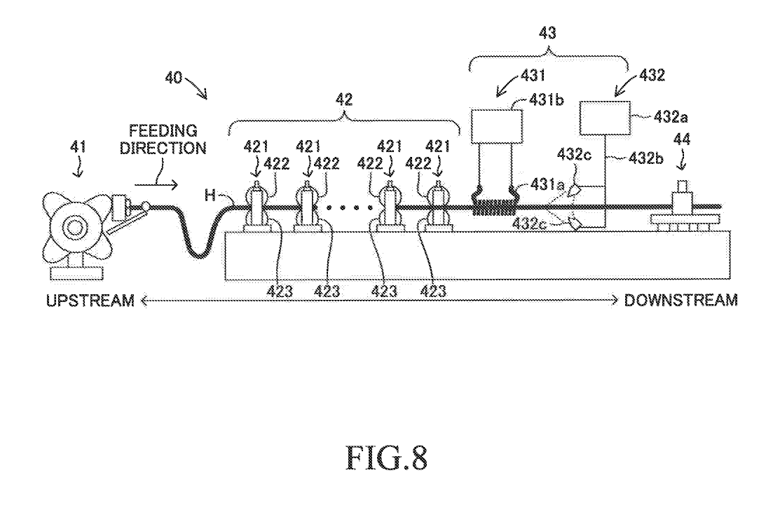

As illustrated in FIG. 8, a roll forming apparatus 40 according to this embodiment includes an uncoiler 41, a forming roll die unit 42, a roll quenching unit 43 serving as the heat-treating device, and a cutting device 44. Those devices are aligned and arranged along a path line in the roll forming apparatus 40 in the above-mentioned order. A steel strip H (metal steel plate) is fed from the uncoiler 41 side (upstream side) to the cutting device 44 side (downstream side). In this case, as illustrated in FIG. 8, a feeding direction of the steel strip H is defined as a direction from the upstream to the downstream.

The uncoiler 41 includes a coil portion around which the steel strip H is wound into a coil, and a rotating device configured to rotate the coil portion. The coil portion is rotated, thereby uncoiling the steel strip H at constant speed.

The forming roll die unit 42 includes a plurality of forming roll stands 421. Each of the forming roll stands 421 includes an upper roll piece 422 and a lower roll piece 423 that are mounted in a vertically aligned fashion so that rotation axes of the upper roll piece 422 and the lower roll piece 423 are arranged in parallel to each other in a vertically separated fashion. The lower roll piece 423 is rotated, thereby feeding the steel strip H. The upper roll piece 422 is rotated by a frictional force generated between the fed steel strip H and the upper roll piece 422. Accordingly, the upper roll piece 422 and the lower roll piece 423 are rotated at the same speed in opposite directions.

The plurality of forming roll stands 421 are arrayed in line along the feeding direction of the steel strip H. The steel strip H uncoiled from the uncoiler 41 is led into the forming roll the unit 42. The steel strip H is plastically deformed every time the steel strip H passes between the upper roll piece 422 and the lower roll piece 423 of each of the plurality of forming roll stands 421. In this manner, the roll formed product having a cross-sectional shape similar to the cross-sectional shape illustrated in FIG. 5 is manufactured (roll forming step). After the forming roll the unit 42 performs roll forming on the steel strip H so that the steel strip H has a desired cross-sectional shape, the steel strip H is fed to the downstream side of the forming roll the unit 42. It is difficult to form, by a usual press forming method, side wall portions (denoted by M2 and M3 in FIG. 9) each having a negative angular portion. However, the side wall portions described above can be easily formed by the roll forming method.

The roll quenching unit 43 is arranged on the downstream side of the forming roll the unit 42. The roll quenching unit 43 includes an induction heater 431 and a cooling water supplying device 432 that are arranged along the feeding direction of the steel strip H in the stated order.

The induction heater 431 is arranged on the downstream side of the forming roll the unit 42 in the feeding direction of the steel strip H. The induction heater 431 includes an induction heating coil 431a arranged so as to surround an outer periphery of the steel strip H that has passed through the most downstream forming roll stand 421, and an energization controller 431b configured to control energization to the induction heating coil 431a. The energization controller 431b energizes the induction heating coil 431a, thereby instantly heating the steel strip H passing through an inside of the induction heating coil 431a. In this embodiment, a heating temperature is adjusted so that the roll formed product is heated to a temperature equal to or higher than an austenitizing temperature. Further, the energization to the induction heating coil 431a is controlled by the energization controller 431b so that the roll formed product is partially heated along the longitudinal direction thereof. In this manner, along the longitudinal direction of the roll formed product, heated portions heated by the induction heating coil 431a, and unheated portions are formed alternately. In this case, an axial length of each heated portion is equal to an axial length of the main body portion 20 of the vehicle door impact beam 10, and an axial length of each unheated portion is equal to a length obtained by coupling two terminal portions 30 of the vehicle door impact beam 10.

The cooling water supplying device 432 includes a cooling water supply source 432a, a supply pipe 432b connected to the cooling water supply source 432a, and cooling water ejection nozzles 432c mounted to distal ends of the supply pipe 432b. Cooling water is supplied from the cooling water supply source 432a through the supply pipe 432b to the cooling water ejection nozzles 432c. Then, the cooling water is ejected from the cooling water ejection nozzles 432c. The cooling water ejected from the cooling water ejection nozzles 432c is sprayed over the steel strip H that has passed through the induction heater 431. In this manner, the heated portion is quenched to a temperature lower than a martensite transformation point, for example, to normal temperature. The heated portion is heat-treated by the quenching. Meanwhile, the unheated portion is not heat-treated. That is, along the longitudinal direction of the roll formed product, heat-treated portions and non-heat-treated portions are formed alternately (partial heat-treating step). After that, the roll formed product is fed to the cutting device 44. The roll formed product is cut into a desired length by the cutting device 44 (cutting step). At this time, a center portion of the unheated portion is cut. Accordingly, the intermediate formed product M having an elongate shape and including both non-heat-treated ends and a heat-treated portion between the both non-heat-treated ends is formed (see FIG. 9). A cross-sectional shape of the intermediate formed product M is the same as the cross-sectional shape of the main body portion 20. That is, the intermediate formed product M includes a bottom wall portion M1, side wall portions M2 and M3, and flange portions M4 and M5 that are similar to those of the main body portion 20. A recessed portion M11 extending in a longitudinal direction of the intermediate formed product M is formed in the bottom wall portion M1. Further, the side wall portions M2 and M3 each include a perpendicular portion perpendicular to the bottom wall portion M1, and an inclined portion inclined to the bottom wall portion M1.

Next, the non-heat-treated portions constructing both ends of the intermediate formed product M are processed by a pressing machine (deforming step). Specifically, the side wall portions 32 and 33 are formed by deforming the side wall portions M2 and M3 into a flat-plate-like shape while outwardly pushing apart the side wall portions M2 and M3 of each longitudinal end of the intermediate formed product M. Further, the protruding portions F are formed by folding the recessed portion M11 of the front end of the intermediate formed product M and the vicinity of the recessed portion M11. In the above-mentioned manner, the vehicle door impact beam 10 is manufactured.

Under a state in which the vehicle door impact beam 10 is arranged so that the bottom wall portions 21 and 31 are opposed to the outer panel OP and that the flange portions 24, 25, 34, and 35 are opposed to the inner panel IP, the flange portions 34 and 35 are welded to the inner panel IP. Under a state in which the vehicle door impact beam 10 is fixed to the inner panel IP, the terminal portions 30 and 30 are held in abutment against the inner panel IP, whereas the main body portion 20 is separated from the inner panel IP.

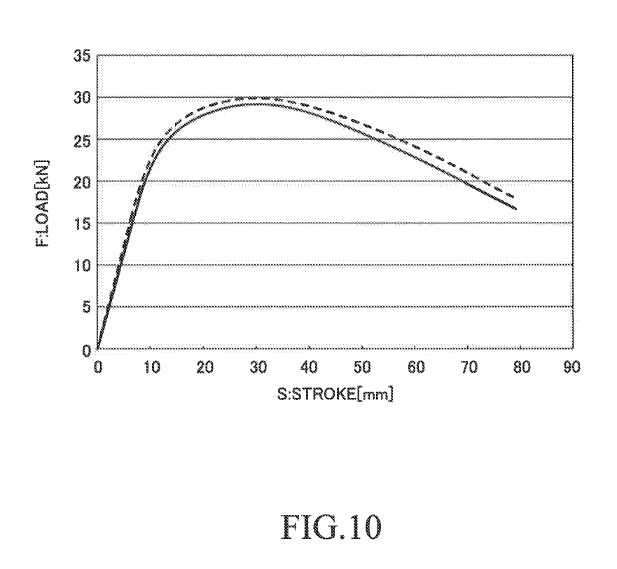

FIG. 10 is a graph of an F-S curve for showing a relationship between a load and a stroke when the both longitudinal ends of the vehicle door impact beam are fixed and a middle portion of the vehicle door impact beam is pressed from a left side of the vehicle door impact beam to a right side thereof. In FIG. 10, characteristics of the vehicle door impact beam 10 according to this embodiment are indicated by the solid line, and characteristics of the above-mentioned related-art vehicle door impact beam are indicated by the broken line. The flange portions 24 and 25 of the vehicle door impact beam 10 are formed to extend outwardly, but the inclined portions 222 and 232 described above are formed. Accordingly, when the middle portion is pressed, the side wall portion 22 and the side wall portion 23 are prevented from being outwardly pushed apart and then causing a sudden reduction in load. That is, each portion of the vehicle door impact beam 10 can be deformed so that the side wall portions 22 and 23 are bent inwardly. In this manner, flexural rigidity of the vehicle door impact beam 10 can be equalized with flexural rigidity of the above-mentioned related-art vehicle door impact beam. As long as dimensions W₂₄ and W₂₅ are in a range of from ⅕ to ½ of the dimension D₂₀ and dimensions D₂₂₁ and D₂₃₁ are in a range of from ⅓ to ⅔ of the dimension D₂₀, the flexural rigidity of the vehicle door impact beam 10 can be equalized with the flexural rigidity of the above-mentioned related-art vehicle door impact beam.

The flange portions 24 and 25 of the main body portion 20 and the flange portions 34 and 35 of each terminal portion 30 are each formed outside the groove. That is, unlike the above-mentioned related-art vehicle door impact beam, there exists no region in which the flange portions extend in opposite directions. That is, stress is prevented from concentrating on an interface portion between the main body portion 20 and each of the terminal portions 30 and 30. Therefore, when an object collides with the door DR, the interface portion between the main body portion 20 and each of the terminal portions 30 and 30 is prevented from breaking prior to deformation of the main body portion 20. Thus, the main body portion 20 is gradually bent, with the result that an impact applied to the door DR is efficiently absorbed.

The dimension D₃₀ of each terminal portion 30 in the vehicle width direction is set to be smaller than the dimension D₂₀ of the main body portion 20 in the vehicle width direction. Therefore, the vehicle door impact beam 10 is also applicable to a vehicle in which a distance (gap) between the inner panel IP and the outer panel OP is small in a region to which the terminal portion 30 is mounted.

The three protruding portions F are formed by folding the recessed portion M11 of the front end of the intermediate formed product M and the vicinity of the recessed portion M11. In this manner, the dimension W₃₀ of the terminal portion 30 in the beam width direction can be minimized without trimming an outer edge portion of the terminal portion 30.

The main body portion 20 is heat-treated, whereas the terminal portions 30 and 30 are not heat-treated. Therefore, in the deforming step, the both longitudinal ends of the intermediate formed product M can be processed relatively easily. Further, as compared to a case where the terminal portions 30 and 30 are heat-treated, it is possible to increase welding strength of the terminal portions 30 and 30 to the inner panel IP.

When carrying out the present disclosure, the present disclosure is not limited to the above-mentioned embodiment, and various modifications may be made without departing from the object of the present disclosure.

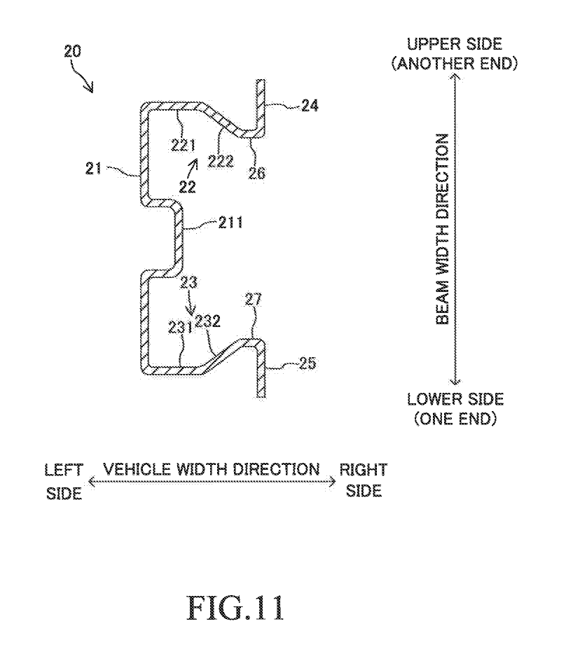

For example, a shape of a connection portion between the flange portion 24 and the inclined portion 222 and a shape of a connection portion between the flange portion 25 and the inclined portion 232 may be modified as follows. In the above-mentioned embodiment, the connection portion between the flange portion 24 and the inclined portion 222 and the connection portion between the flange portion 25 and the inclined portion 232 are curved significantly. Instead, as illustrated in FIG. 11, the flange portion 24 and the inclined portion 222 may be connected to each other through intermediation of a wall portion 26 parallel to the perpendicular portion 221, and the flange portion 25 and the inclined portion 232 may be connected to each other through intermediation of a wall portion 27 parallel to the perpendicular portion 231.

A feature of one embodiment of the present disclosure resides in a vehicle door impact beam (10) to be arranged inside a vehicle door (DR), the vehicle door impact beam comprising: a main body portion (20) formed into an elongate shape; and a pair of terminal portions (30) formed at both longitudinal ends of the main body portion, respectively, wherein the main body portion comprises: a first bottom wall portion (21) extending in a predetermined direction; a pair of first side wall portions (22,23) being connected to both widthwise ends of the first bottom wall portion, respectively, and extending in the predetermined direction to be opposed to each other; and a pair of first flange portions (24,25) respectively extending from widthwise ends of the pair of first side wall portions in a direction away from each other, wherein the main body portion is formed into a shape of a groove that is open in one direction, wherein the first side wall portion comprises: a pair of first wall portions (221,231) respectively extending from the both widthwise ends of the first bottom wall portion toward the one direction; and pair of second wall portions (222,232) respectively extending from ends of the pair of first wall portions on the one direction side toward the one direction, and being inclined so as to approach each other as extending from ends of the pair of second wall portions on the pair of first wall portions side toward ends of the pair of second wall portions on the one direction side, wherein the terminal portion comprises: a second bottom wall portion (31) extending in the predetermined direction; a pair of second side wall portions (32,33) being connected to both widthwise ends of the second bottom wall portion, respectively, and extending in the predetermined direction to be opposed to each other; and a pair of second flange portions (34,35) respectively extending from widthwise ends of the pair of second side wall portions in a direction away from each other, wherein the terminal portion is formed into a shape of a groove that is open in the one direction, wherein the pair of second side wall portions are inclined away from each other as extending from ends of the pair of second side wall portions on the second bottom wall portion side toward ends of the pair of second side wall portions on the one direction side.

In this case, it is preferred that a width of each of the pair of first wall portions be set in a range of from one third to two thirds of a depth of the groove of the main body portion. Note that, the “width of each of the pair of first wall portions” means a direction parallel to a groove depth direction of the main body portion.

Further, in this case, it is preferred that a width of each of the pair of first flange portions of the main body portion be set in a range of from one fifth to a half of the depth of the groove of the main body portion. Note that, the “width of each of the pair of first flange portions” means a direction parallel to a groove width direction of the main body portion.

With this, the first flange portions of the main body portion of the vehicle door impact beam are formed so as to extend toward an outside of the groove, but the second wall portions described above are formed. Thus, when a middle portion of the main body portion is pressed, the first side wall portions are prevented from being outwardly pushed apart and then causing a sudden reduction in load. That is, each portion of the vehicle door impact beam can be deformed so that the first side wall portions are bent inwardly. In this manner, flexural rigidity of the vehicle door impact beam can be equalized with flexural rigidity of the above-mentioned related-art vehicle door impact beam.

Further, the first flange portions of the main body portion and the second flange portions of each terminal portion are formed to extend outwardly. That is, unlike the above-mentioned related-art vehicle door impact beam, there exists no region in which the flange portions extend in opposite directions. That is, stress is prevented from concentrating on an interface portion between the main body portion and the terminal portion. Therefore, when an object collides with a door, the interface portion between the main body portion and the terminal portion is prevented from breaking prior to deformation of the main body portion. Thus, the main body portion is gradually bent, with the result that an impact applied to the door is efficiently absorbed.

Further, another feature of one embodiment of the present disclosure resides in that a depth of the groove of the each of the pair of terminal portions is smaller than the depth of the groove of the main body portion, and that a width of the each of the pair of terminal portions is larger than a width of the main body portion.

With this, a dimension of each terminal portion in a vehicle width direction is set to be smaller than a dimension of the main body portion in the vehicle width direction. Thus, the vehicle door impact beam is also applicable to a vehicle in which a distance (gap) between an inner panel and an outer panel is small in a region to which the terminal portion is mounted.

Further, another feature of one embodiment of the present disclosure resides in that among the main body portion and the pair of terminal portions, only the main body portion is heat-treated.

In this manner, the terminal portions can be formed relatively easily. Further, as compared to a case where the terminal portions are also heat-treated, it is possible to increase welding strength in a case of welding the terminal portions to a door panel.

What is claimed is:

1. A vehicle door impact beam to be arranged inside a vehicle door, the vehicle door impact beam comprising:
a main body portion formed into an elongate shape; and
a pair of terminal portions formed at both longitudinal ends of the main body portion, respectively,
wherein the main body portion comprises:
a first bottom wall portion extending in a predetermined direction;
a pair of first side wall portions being connected to both widthwise ends of the first bottom wall portion, respectively, and extending in the predetermined direction to be opposed to each other; and
a pair of first flange portions respectively extending from widthwise ends of the pair of first side wall portions in a direction away from each other,
wherein the main body portion is formed into a shape of a groove that is open in one direction,
wherein the first side wall portion comprises:
a pair of first wall portions respectively extending from the both widthwise ends of the first bottom wall portion toward the one direction; and
a pair of second wall portions respectively extending from ends of the pair of first wall portions on the one direction side toward the one direction, and being inclined so as to approach each other as extending from ends of the pair of second wall portions on the pair of first wall portions side toward ends of the pair of second wall portions on the one direction side,
wherein the terminal portion comprises:
a second bottom wall portion extending in the predetermined direction;
a pair of second side wall portions being connected to both widthwise ends of the second bottom wall portion, respectively, and extending in the predetermined direction to be opposed to each other; and
a pair of second flange portions respectively extending from widthwise ends of the pair of second side wall portions in a direction away from each other,
wherein the terminal portion is formed into a shape of a groove that is open in the one direction,
wherein the pair of second side wall portions are inclined away from each other as extending from ends of the pair of second side wall portions on the second bottom wall portion side toward ends of the pair of second side wall portions on the one direction side.

2. A vehicle door impact beam according to claim 1,
wherein a depth of the groove of the each of the pair of terminal portions is smaller than a depth of the groove of the main body portion, and
wherein a width of the each of the pair of terminal portions is larger than a width of the main body portion.

3. A vehicle door impact beam according to claim 1,
wherein a width of each of the pair of first wall portions is set in a range of from one third to two thirds of the depth of the groove of the main body portion.

4. A vehicle door impact beam according to claim 1,
wherein a width of each of the pair of first flange portions of the main body portion is set in a range of from one fifth to a half of the depth of the groove of the main body portion.

5. A vehicle door impact beam according to claim 1,
wherein among the main body portion and the pair of terminal portions, only the main body portion is heat-treated.

6. A method of manufacturing a vehicle door impact beam to be arranged inside a vehicle door, the method comprising:
a forming step of manufacturing an intermediate formed product being formed into a shape of a groove that is open in one direction, the intermediate formed product comprising:
a bottom wall portion extending in a predetermined direction;
a pair of side wall portions being connected to both widthwise ends of the bottom wall portion, respectively, and extending in the predetermined direction to be opposed to each other; and
a pair of flange portions respectively extending from widthwise ends of the pair of side wall portions in a direction away from each other,
the pair of side wall portions comprising:
a pair of first wall portions respectively extending from the both widthwise ends of the bottom wall portion toward the one direction; and
a pair of second wall portions respectively extending from ends of the pair of first wall portions on the one direction side toward the one direction, and being inclined so as to approach each other as extending from ends of the pair of second wall portions on the pair of first wall portions side toward ends of the pair of second wall portions on the one direction side,
the pair of flange portions being arranged outside a space surrounded by the bottom wall portion and the pair of side wall portions;
a heat-treating step of heat-treating a middle portion of the intermediate formed product excluding both longitudinal ends of the intermediate formed product; and
a deforming step of deforming the pair of side wall portions of each of both the longitudinal ends of the intermediate formed product into a plate-like shape extending along an inner surface of the vehicle door.

7. A method of manufacturing the vehicle door impact beam according to claim 6,
wherein the deforming step comprises a pressing step of pushing apart longitudinal ends of both the pair of side wall portions of the intermediate formed product toward an outside of the space.
